(19) United States
(12) Patent Application Publication
(10) Pub. No.: US 2008/0058075 A1
(43) Pub. Date: Mar. 6, 2008

(54) WAGERING GAMES FEATURING AUDIOVISUAL OUTPUT AND INDICIA RELATED THERETO

(76) Inventors: Jay S. WALKER, Ridgefield, CT (US); Michael W. PATTERSON, New York, NY (US); Robert C. TEDESCO, Fairfield, CT (US); Daniel E. TEDESCO, Huntington, CT (US); James A. JORASCH, Westport, CT (US)

Correspondence Address: WALKER DIGITAL MANAGEMENT, LLC, 2 High Ridge Park, Stamford, CT, 06905, US

(21) Appl. No.: 11/845,424

(22) Filed: Aug. 27, 2007

Related U.S. Application Data
(60) Provisional application No. 60/824,344, filed on Sep. 1, 2006.

(51) Int. Cl. A63F 13/10

(52) U.S. Cl. 463/20; 463/25

(57) ABSTRACT

A gaming device is thematically tied to audiovisual content that has been repurposed from its original use and adapted to use with the gaming device. For example, the gaming device may be thematically tied to a television situational comedy. Instead of making a general wager and spinning the reels, a player selects particular symbols or characters that are thematically tied to the audiovisual content, and places a wager on the selected symbols or characters. The reels of the gaming device spin and a random selection of symbols and images of characters are presented on a payline of the gaming device. If the player has selected an image or symbol that lands on the payline, an audiovisual clip based on the theme is played and the player is informed of her winning outcome.

### RELATED APPLICATIONS

The present application claims the benefit of and priority to U.S. Provisional Application Ser. No. 60/824,344, filed Sep. 1, 2006, the entirety of which is hereby incorporated by reference.

The present disclosure is also related to U.S. Patent Publication No. 2004/0005918, filed Apr. 16, 2003.

The present disclosure is also related to U.S. Patent Publication No. 2003/0211881, filed Apr. 16, 2003.

The present disclosure is also related to U.S. Patent Publication No. 2006/0003830, filed May 23, 2005.

The present disclosure is also related to U.S. patent application Ser. No. 11/570,643, filed Dec. 14, 2006.

The present disclosure is also related to U.S. Patent Publication No. 2005/0288096, filed Jun. 22, 2005.

The disclosure of each of the above referenced applications is hereby incorporated by reference in its entirety.

### FIELD OF THE INVENTION

The present invention is related to electronic gambling devices and more particularly to electronic gambling devices that present repurposed audiovisual entertainment content as part of the revelation of a game outcome.

### BRIEF DESCRIPTION OF THE DRAWINGS

FIG. 1 illustrates an exemplary gaming device suitable for use with some embodiment.

FIG. 2 illustrates a block diagram of an exemplary gaming device suitable for use with some embodiments.

FIG. 3 illustrates a mobile terminal usable as a gaming device according to at least one embodiment.

FIG. 4 illustrates a network of gaming devices with a controller according to some embodiments.

FIG. 5 illustrates a flow chart of an exemplary methodology according to some embodiments.

FIG. 6 illustrates an exemplary database that may be used in at least one embodiment of the present disclosure.

### DETAILED DESCRIPTION OF THE INVENTION

A gaming machine allows players to place bets on various indicia. The indicia are thematically tied to audiovisual content. Once the player has indicated an indicium on which a will be placed, the player initiates a game start. The player is presented a plurality of spinning reels which stop, having certain images or symbols on a payline. If at least one of the images or symbols on the payline corresponds to the indicia on which the player has wagered, audiovisual content is then played by the gaming device. In an exemplary embodiment, the audiovisual content includes the character or thing on which the player wagered. The player is informed of a payout for the wager. Numerous permutations and variations on this concept are possible and within the scope of the present disclosure. Before addressing the particulars of the hardware that supports the present concepts, an example is provided.

A gaming device is thematically tied to a television situational comedy such as THREES COMPANY. The gaming device has input buttons displaying the characters of the sitcom such as Chrissy, Jack, Mr. Roper, Janet, and the like. A player selects Jack and Chrissy and initiates a game start. The reels spin and show Janet-Janet-Chrissy. The control system for the gaming device selects an audiovisual clip having Jack and Chrissy talking in the apartment and plays the audiovisual clip to the player. The player laughs as he watches the clip and is then told that he won ten credits, further improving the mood of the player.

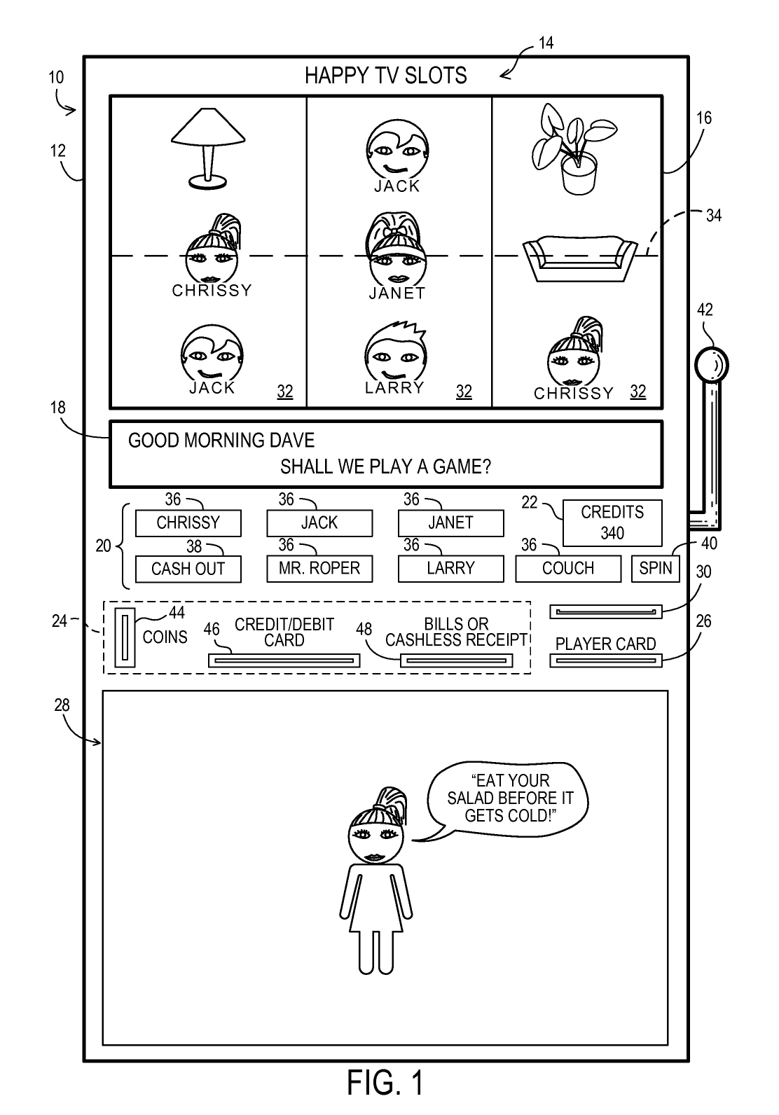

Before addressing the methods of the present disclosure, an overview of some of the hardware elements is provided. FIG. 1 illustrates a front elevational view of a gaming device 10, which is, as illustrated, a three-reel video slot machine. The gaming device 10 includes a housing 12 boasting game name indicia 14 and a primary display 16 on which the game action is presented. Game name indicia 14 may be thematically tied to the other elements of the gaming device 10. A secondary display 18 presents images and text to provide supplemental information or instructions to the player as practical or desired. Note that while this disclosure explicitly contemplates certain information being output by one display, it is within the scope of the present disclosure to have different displays output given information.

An input keypad 20 includes a plurality of buttons through which the player may provide input to the gaming device 10. A credit meter 22 displays a current total of credits available to the player. Credits may be established by the player through the use of an equity input mechanism 24 or through game play as will be further described herein.

A player-tracking mechanism 26 may be used to identify a player at the gaming device 10, which, in turn, may allow messages on the secondary display 18 to be personalized, comp points posted to the player profile, and the like. Audiovisual display 28 provides a display for audiovisual content that is thematically tied to the other elements of the gaming device 10.

A ticket dispenser 30 may be used to dispense cashless gaming tickets. While only a slot is illustrated, it should be appreciated that a printer and appropriate paper feeding mechanisms are positioned behind the slot as is well understood.

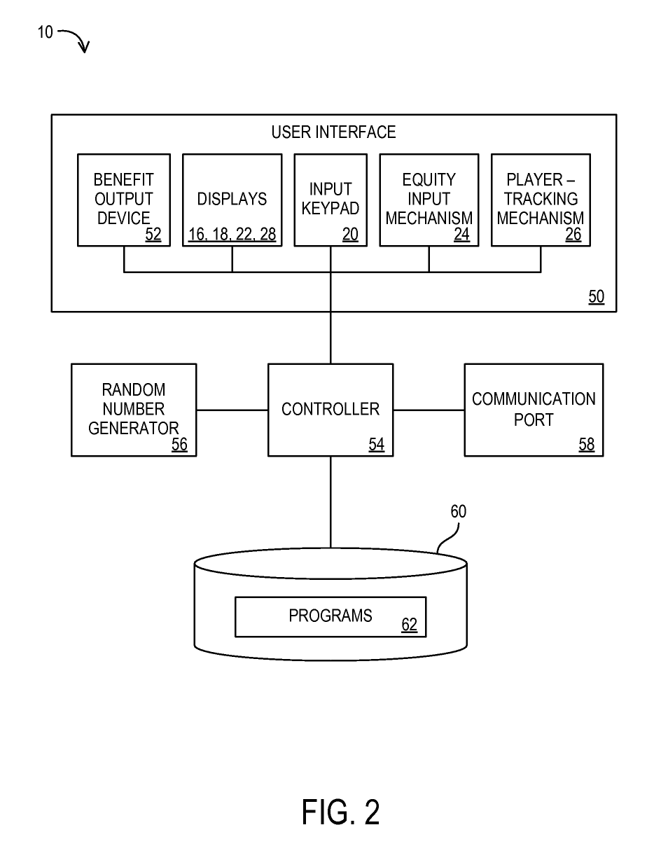

Collectively, the displays 16, 18, 28, input keypad 20, credit meter 22, equity input mechanism 24, player-tracking mechanism 26, and ticket dispenser 30 may be thought of as a user interface 50 (see FIG. 2) for the gaming device.

More particularly, the primary display 16 presents, in this exemplary embodiment, three reels 32 with images and symbols thereon. A payline 34 is illustrated stretching across the images on the reels 32. While only three reels are shown, more or fewer reels may be used if desired. Additionally, the reels may be physical reels such as those driven by stepper motors or video reels. When not actively conducting game play, the gaming device 10 may present an attraction screen or video clip designed to draw attention to the gaming device 10 and entice a player to begin game play on the gaming device 10.

Audiovisual display 28 is adapted to present audiovisual clips to the player as dictated by the game play of the gaming device 10. In embodiments where the primary display 16 is a video display, with video reels thereon, audiovisual display 28 may be integrated into the primary display 16. It should be appreciated that the audiovisual display 28 may be repositioned on the housing 12 or even removed to a peripheral device as desired.

The primary display 16, secondary display 18, the credit meter 22, and the audiovisual display 28 are “displays” as that term is defined in the Rules of Interpretation set forth below.

Input keypad 20 may include wager buttons 36. The wager buttons 36 identify characters or elements that are thematically tied to the gaming device 10. For example, continuing the THREE'S COMPANY theme introduced above, the wager buttons 36 may correspond to JACK, CHRISSY, JANET, MR. ROPER, MRS. ROPER (not shown), LARRY, MR. FURLEY, THE COUCH, and the like as desired. Other elements such as a plant, a Christmas tree, other characters, or the like could be used. However, each element or character on the wager buttons 36 should also have a corresponding symbol on the reels 32. Conversely, not every symbol on the reels 32 has to have a wager button 36. While illustrated as having textual indicia on the buttons 36, it is possible that an image may be presented instead of or in addition to the textual indicia.

In a first embodiment, pressing a wager button causes the player to wager one credit on that symbol. It is worth noting that the gaming device 10 operates using units of wager as that term is defined in the Rules of Interpretation set forth below. Each credit herein corresponds to a unit of wager. The player may select how many units of wager are to be bet by pressing a corresponding number of wager buttons 36. Continuing the example introduced above, if the player presses the JACK button, the CHRISSY button, and the JANET button, the player will have wagered three credits. In a second embodiment, the symbols are weighted such that different symbols have different wager requirements. For example, JACK is a popular character, so to wager on JACK, the player may wager three credits when the player presses the wager button 36 corresponding to JACK. In a third embodiment, additional units may be wagered through repeated activation of a particular wager button 36. For example, if the player presses the wager button 36 corresponding to CHRISSY three times, then three credits have been wagered on CHRISSY. In other embodiments, more or fractional units of wager may be bet by the player as practical or desired.

Input keypad 20 may further include a cash out button 38, which allows players to receive any credits that are currently available as indicated by the credit meter 22. Such cash out buttons 38 are well understood in the industry. Note that input keypad 20 may be actual mechanical buttons or incorporated into a touch screen display as practical or desired.

Input keypad 20 may still further include a start mechanism. In a first embodiment, the start mechanism is a spin button 40. In a second embodiment, the start mechanism is a handle 42. While not strictly a button, the handle 42 is, for the purposes of the present disclosure, defined to be part of an input keypad 20. The player initiates a game start by pressing the spin button 40 or pulling the handle 42. Other start mechanisms may be used as practical or desired.

The equity input mechanism 24 may include a coin acceptor 44, a magnetic card reader 46, a paper acceptor 48 and/or the like. Magnetic card reader 46 may accept credit, debit or other form of card including a smart card or the like. The paper acceptor 48 may accept bills in appropriate denominations and/or be a cashless gaming receipt acceptor. Players may use any or all the input devices of the equity input mechanism 24 to establish equity in the gaming device 10 and fund wagers. When the player provides such equity, the amount appears on the credit meter 22. In an exemplary embodiment, each credit is equal to a unit of wager. The credit meter 22 reflects the amount of electronic credits currently available to a player for any purpose. A player, for example, may use the electronic credits as wagers for games played on the gaming device 10. The electronic credits may also be “cashed out” as further explained below.

While not shown, the equity input mechanism 24 could include a radio frequency identification (RFID) interrogator that interoperates with a player-controlled transponder (e.g., incorporated into a key fob, a “contactless” player card, or the like). The interrogator could retrieve an account number (e.g., a credit card account, a bank account, a player account, or the like) from the transponder and establish equity therethrough. As yet another alternative, the player may use a cellular phone (or other mobile terminal) and call a number displayed on the gaming device 10. The gaming device 10 may then bill the cellular phone account of the player. As yet another option, the mobile terminal may communicate with the gaming device 10 through some other protocol (e.g., BLUETOOTH™ or WI-FI™) and provide account information to the gaming device 10 such that the account may be billed as practical or desired. A smart card or dongle with an electronic wallet stored thereon, or other similar structure could be used in conjunction with an appropriate dongle port. Still other mechanisms for establishing equity may be used if practical or desired. In place of providing a benefit through the coin hopper or a cashless gaming receipt, funds may be credited to an account that was used to establish equity (e.g., a credit applied to a cellular phone account, direct deposit to a bank, and the like) or other account associated with the player (e.g., such as an account associated with a player-tracking profile).

The player-tracking mechanism 26 may be a magnetic card reader into which the player inserts a magnetic stripe player-tracking card. While illustrated as a magnetic card reader, it should be appreciated that the player-tracking mechanism 26 could be a smart card reader, a bar code reader, a dongle port, or other mechanism such as a wireless interrogator that interrogates a RFID device such as a transponder positioned in a key chain fob or the like. In still another embodiment, the player-tracking mechanism 26 may be a biometric input such as a fingerprint reader, a retinal scanner, or the like. Such inputs may be accompanied by a keypad for PIN entry if practical or desired. Acknowledgement of use of a player-tracking device may be made on the secondary display 18 or other location as practical or desired.

The audiovisual display 28 is, as noted above, a display as that term is defined in the Rules of Interpretation. In particular, the audiovisual display 28 is adapted to present audiovisual clips thematically tied to the theme of the gaming device to help show the player that the player has received a winning outcome. While not explicitly shown, it is should be understood that the gaming device includes speakers so that the audio portion of the audiovisual clip may be provided to the player during playback.

The player may cash out by pressing the cash out button 38. In such a circumstance, the ticket dispenser 30 may print a ticket which lists a cash value for the credits that had been displayed on the credit meter 22. Thus, for a quarter denomination slot machine, the ticket dispenser would provide a dollar cash value of the number of credits divided by four. Alternatively benefits may be output through a coin hopper (not shown). Both the ticket dispenser 30 and such coin hoppers are well understood in the slot industry.

A block diagram of the gaming device 10 is illustrated in FIG. 2. In particular, the gaming device 10 includes the user interface 50, which includes the displays 16, 18, 22, 28, the input keypad 20, the equity input mechanism 24, the player-tracking mechanism 26, and a benefit output device 52 (e.g., a coin hopper or ticket dispenser 30). The user interface 50 is operatively coupled to a controller 54. The controller 54 may further be operatively coupled to a random number generator 56 and a communication port 58. Memory 60 with programs 62 stored therein is further operatively associated with the controller 54. The elements of the gaming device 10 may communicate over a wirebased bus (not shown explicitly) or wirelessly as practical or desired. The controller 54 with memory 60 and the programs 62 is a control system as that term is defined in the Rules of Interpretation.

Note that while the user interface 50 has been described in terms of discrete buttons and displays, it is possible, as alluded to above, that the buttons of the input keypad 20 may be incorporated into one or more displays through the use of a touch screen. Extending this concept, the touch screen may include menus and active buttons from which a player may select various options relating to her gaming experience. An exemplary option may be supplemental audio played through speakers on the gaming device 10. This option may be selected from a menu. Such menus may be WINDOWS® style drop down menus that appear when a player touches a particular portion of the touch screen, selectively enabled through the actions of the player, or otherwise made available as practical or desired. Once the menu appears, the touch screen may make the menu active such that a player may make a selection from the menu by touching the area of the screen on which the option appears. While a WINDOWS® style menu option is possible, other presentations are also possible. As is readily understood, such a touch screen may require a touch screen controller with the menus stored in appropriate memory devices (e.g., memory 60) associated with the gaming device 10. Likewise, the content that is selected from such menus must be available either locally or remotely so that the gaming device 10 may present such content. In some embodiments, the display of such menus may preempt the display of other information. For example, in one embodiment, the menus may appear on the audiovisual display 28 and, when the menus are active, the audiovisual clips may be obscured by the menus. Other arrangements are also contemplated.

The controller 54 may be positioned within the housing 12 of the gaming device 10. Memory 60 may also be positioned within the housing 12 and may be a computer readable medium as that term is defined in the Rules of Interpretation. The software programs 62 include instructions for making the controller 54 operate. The software programs 62 may be stored in a compressed, uncompiled, and/or encrypted format. The software programs 62 may include program elements that are necessary for operation of the controller 54 such as an operating system, a database management system, device drivers, and the like. The software programs 62 may be uploaded into the memory 60 through any appropriate mechanism such as installation from a floppy, CD, or DVD drive, downloaded from a network through communication port 58, or other mechanism as is well understood. While not explicitly illustrated, memory 60 may store a probability database and/or a payout database. The book “Winning At Slot Machines” by Jim Regan (Carol Publishing Group Edition, 1997) illustrates examples of payout and probability tables and how they may be derived. The entirety of this book is incorporated by reference herein.

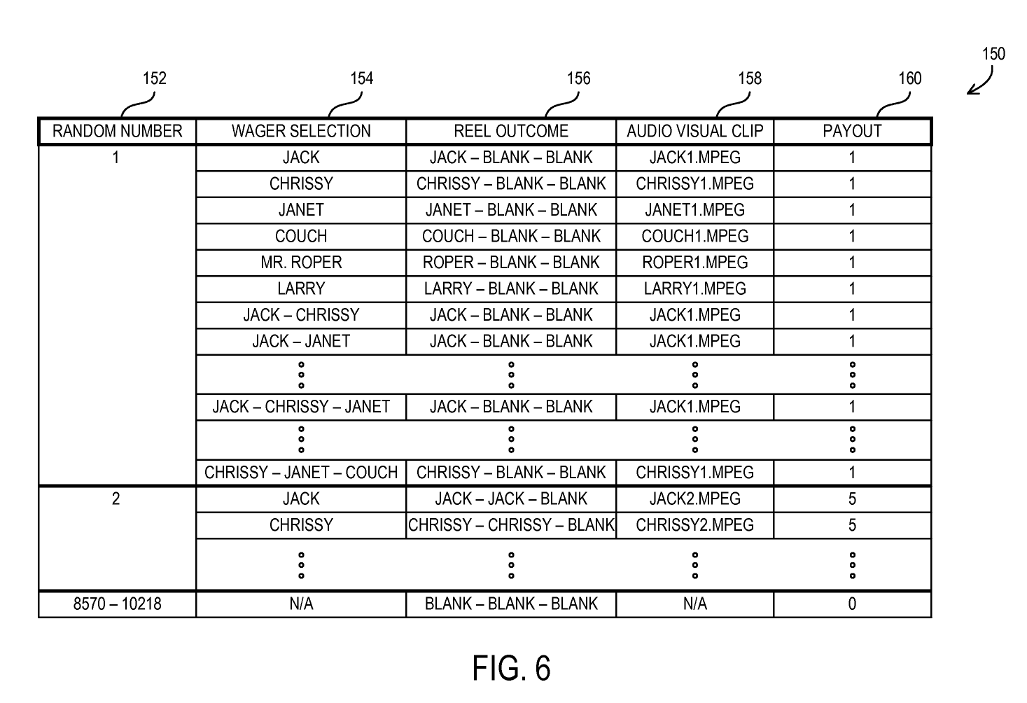

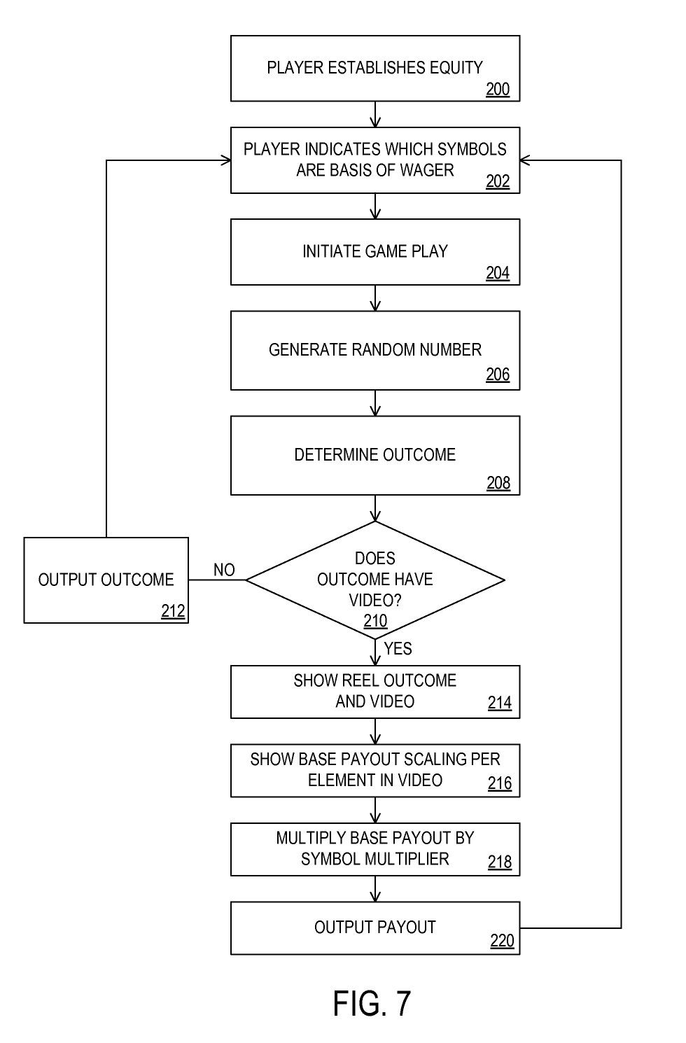

Such a paytable database may include an attribute entry defining an attribute, a threshold for the attribute above which the player has qualified for a winning outcome, and a benefit entry which may include a number of credits, comp points, or other value to be awarded to the player. Other arrangements are also possible. Note that the benefit may be a cash value benefit, a comp point, a free game start, an element such as a token redeemable for a free game start, a bonus game start, access to an improved paytable, access to some form of premium play, a ticket to a show, a ticket for a discount at a restaurant, or the like. Note that the premium play may be selected from a menu, which may include forms of insurance, improved paytables, reduced wager requirements, and the like. More information on particularly contemplated databases is presented below with reference to FIGS. 6-8.

Memory 60 may further contain the audiovisual files that are presented in audiovisual display 28. These audiovisual files may be stored in any appropriate format such as .mpg, .wav, or the like. These audiovisual files may be segments or portions of a full audiovisual program. Alternatively, each file may be a complete program, but indices associated with the audiovisual file may be used to track audiovisual clips that are partial versions of the complete audiovisual file. For example, something analogous to a chapter or scene selection menu for a DVD may be used to identify subportions of the audiovisual file. For more information on storage, maintenance, and use of audiovisual files in a gaming device, the interested reader is referred to U.S. Pat. No. 6,234,896 and U.S. Patent Publication Nos. 2004/0005918 and 2006/0003830, previously incorporated.

The random number generator 56 (as well as any other random number generator described herein), in accordance with at least one embodiment, may generate data representing random or pseudo-random values (referred to as “random numbers” herein). The random number generator 56 may generate a random number every predetermined unit of time (e.g., every second) or in response to an initiation of a game on the gaming device 10. In the former embodiment, the generated random numbers may be used as they are generated (e.g., the random number generated at substantially the time of game initiation is used for that game) and/or stored for future use in the memory 60.

The random number generator 56, as used herein, may be embodied as a processor separate from but working in cooperation with controller 54. Alternatively, the random number generator 56 may be embodied as an algorithm, program component, or software program 62 stored in the memory 60 or other device and used to generate a random number.

Note that, although the generation or obtainment of a random number is described herein as involving the random number generator 56, other methods of determining a random number may be employed. For example, a gaming device owner or operator may obtain sets of random numbers that have been generated by another entity. HotBits™, for example, is a service that provides random numbers that have been generated by timing successive pairs of radioactive decays detected by a Geiger-Muller tube interfaced to a computer. A blower mechanism that uses physical balls with numbers thereon may be used to determine a random number by randomly selecting one of the balls and determining the number thereof.

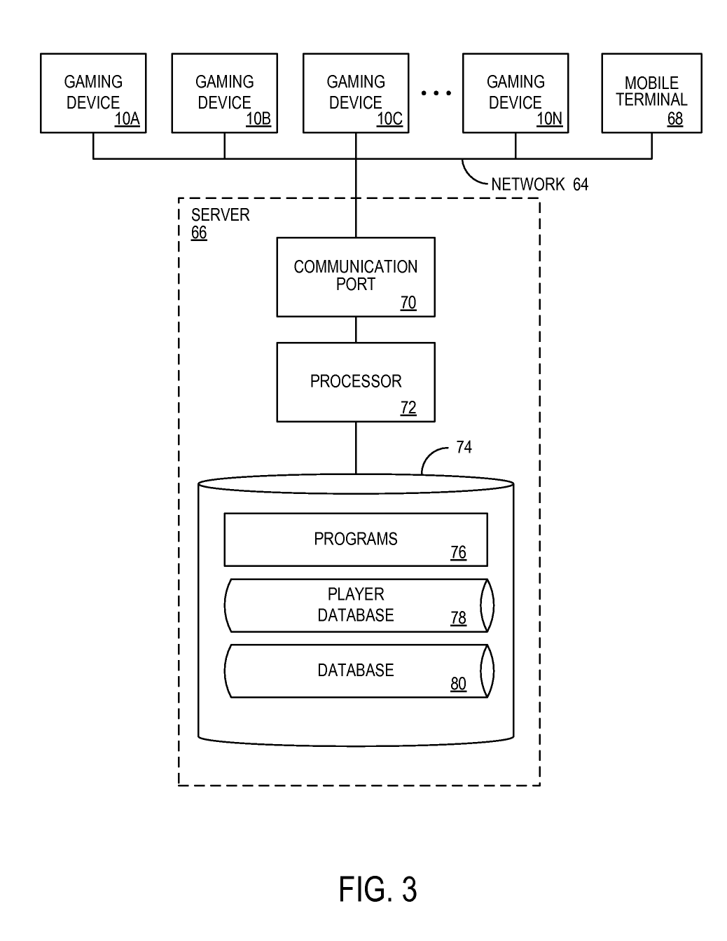

The communication port 58 may connect the gaming device 10 to a communication network 64 (FIG. 3) through any appropriate communication medium and protocol. An exemplary communication port 58 is an Ethernet port that connects the gaming device 10 to an internet protocol (IP) network.

While not illustrated, some of the components of the gaming device 10 may be embodied as a peripheral device that is operatively associated with the gaming device 10. Such peripheral devices may be mounted on or positioned proximate to the housing 12 of the gaming device 10 as practical or desired. Such peripheral devices may be particularly useful in retrofitting functionality into the gaming device 10. Alternatively, a retrofit package may be assembled including new belly glass and an EEPROM chip that is installed in the memory 60 with the new programs 62 that enable the functionality of one or more embodiments.

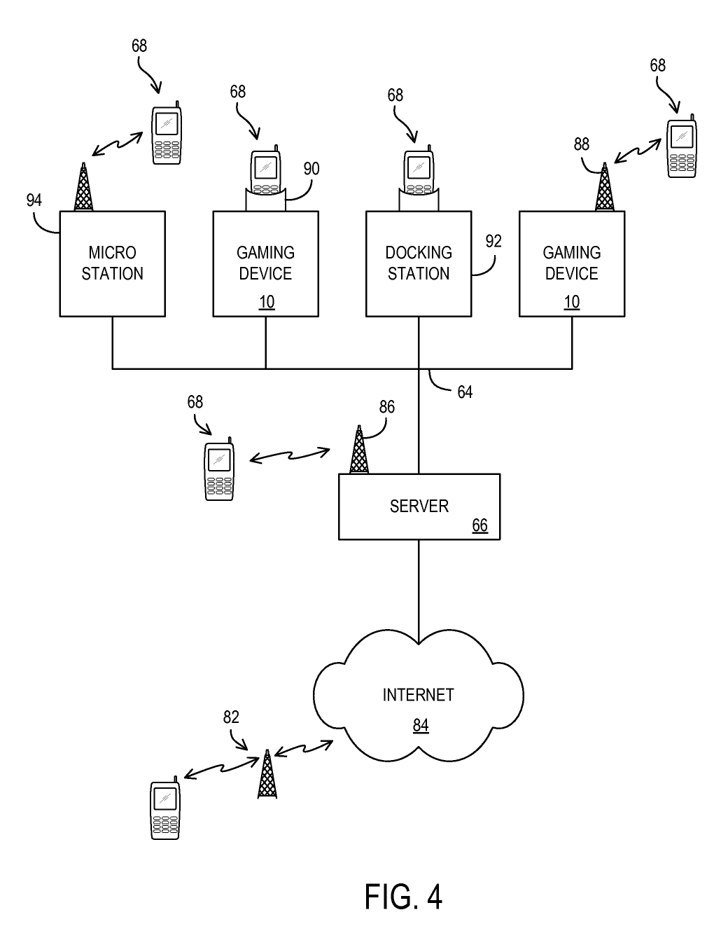

The gaming device 10 may be a stand-alone device or it may be connected to the network 64 as better illustrated in FIG. 3. For example, gaming devices 10A-10N may be connected through the network 64 to a server 66. Additionally a mobile terminal 68 may be connected to the network 64. More information on the mobile terminal 68 and its operation within the network 64 is provided below with reference to FIG. 4. Network 64 is a network as that term is defined in the Rules of Interpretation.

The server 66 may include a communication port 70 adapted to couple operatively the server 66 to the network 64 and a processor 72. The processor 72 may be operatively coupled to memory 74 with programs 76 stored thereon. A player database 78 and other databases 80 may further be stored on the memory 74 as practical or desired. The processor 72 coupled with the programs 76 is a control system as that term is defined in the Rules of Interpretation.

The server 66 may perform some of the functionality previously attributed to the gaming device 10. That is, the gaming devices 10 may act as client devices for the server 66 with most of the processing and decision making occurring on the server 66. In such an instance, the processor 72 is operatively coupled to the user interface 50 through the network 64 and acts as the control system for the gaming device 10. The memory 74 may store additional databases, including, but not limited to: a game database that stores information regarding one or more games playable on and/or downloadable to one or gaming devices 10, a bundled database that bundles reel symbols with audiovisual clips, and a scheduling and/or configuration database useful for determining which games are to be made available on which gaming devices 10 at what times. Such downloads may be used to switch between modes of operation of the gaming device 10 if desired. In another exemplary embodiment, the audiovisual files may be stored in memory 74 rather than memory 60, and these audiovisual files may be selectively downloaded or streamed to the gaming device 10. In other embodiments, some or all of these functions may be handled by a device distinct from the server 66, but remotely positioned relative to the gaming devices 10.

In place of the payout and probability databases being present in the gaming devices 10, such databases and/or data may instead be stored in the databases 80 of the memory 78. Likewise, the databases may be distributed and/or duplicated between various devices within the network 64.

The programs 76 may allow the server 66 to track gambling, gaming, or other activity performed at the gaming device 10, track gaming or other activities of individual players, instruct a gaming device 10 to perform one or more functions (e.g., output a message to a player, interrupt play, or the like), assign or otherwise determine a unique identifier for a player, and/or control access to stored funds and/or a credit line. In some embodiments the server 66 may be operable to configure a gaming device 10 remotely, update software stored on a gaming device 10, and/or download software or software components to a gaming device 10. For example, the server 66 may be operable to apply a hot fix to software stored on a gaming device 10, modify a payout and/or probability table stored on a gaming device 10, and/or transmit a new version of software and/or a software component to a gaming device 10. The server 66 may be programmed to perform any or all of the above functions as practical or desired and may do so based on, for example, an occurrence of an event (e.g., a scheduled event), receiving an indication from authorized gaming establishment personnel, an authorized third party (e.g., a regulator) and/or receiving a request from a player. In other embodiments, some or all of these functions may be handled by a device distinct from the server 66.

While the previous paragraph describes the server 66 configuring the gaming device 10, it is also possible that the server 66 stores games thereon, and these games are requested from the gaming device 10. The gaming device 10 may be programmed to check periodically if updates are available, and, if an update is available, download and install the update. Alternatively, the gaming device 10 may check on occurrence of an event, an indication from authorized gaming establishment personnel, an indication from an authorized third party, or the like. It is particularly contemplated that the gaming device 10 may be a thin client controlled by the server 66, although such is not required for operation.

In some embodiments, game play may be conducted on a mobile terminal 68 instead of a gaming device 10. FIG. 4 illustrates a variety of techniques through which the mobile terminal 68 may be so used. The illustrated techniques are intended to be exemplary and non-limiting. The mobile terminal 68 may be a cellular telephone, a personal digital assistant (such as a PALM® or BLACKBERRY™ device), a two way pager, a portable computer, a personal computer, a handheld gaming device (such as a NINTENDO GAMEBOY, the LS800 Tablet PC by Motion Computing Inc of Austin Tex., the iPAQ hw6920 by Hewlett Packard of Palo Alto Calif., or a wireless device marketed by DIAMOND I, INC.), or the like as practical or desired. In short, the mobile terminal 68 may be a device dedicated to gambling or a multipurpose device such as a cellular phone on which games may be played as practical or desired. The mobile terminal 68 includes a user interface including a keypad, microphone, speaker, and display. The mobile terminal 68 further includes a controller or processor with corresponding software stored in a local memory that acts as a control system as that term is defined in the Rules of Interpretation. Alternatively, the user interface of the mobile terminal 68 may be controlled by a remotely positioned control system such as the processor 72.

In one embodiment, the mobile terminal 68 may communicate through a wireless network 82 (e.g., such as the public land mobile network (PLMN)) to the internet 84, and through the internet 84 to an online casino server (not shown explicitly) or other server 66. In such an embodiment, the mobile terminal 68 may be equipped with a web browser (e.g., FIREFOX, MOZILLA, NETSCAPE NAVIGATOR, INTERNET EXPLORER, etc.) to interoperate with the online casino. While the internet 84 is contemplated, the public switched telephone network (PSTN) or other communication network may be used in place thereof as practical or desired. Alternatively, the mobile terminal 68 may download the game from such a server, and the game may be played locally.

As yet another option, the mobile terminal 68 may instead communicate with elements of the network 64. In one embodiment, the mobile terminal 68 communicates with the server 66 through an antenna 86 coupled to the server 66 using an appropriate wireless protocol. In a second embodiment (not shown), the mobile terminal 68 may dock directly with the server 66 using appropriate docking technology. Note that this embodiment may require appropriate security and firewalls since the player will have essentially direct access to the server 66. In another embodiment, the mobile terminal 68 may communicate with a gaming device 10 through an antenna 88. Note that the antenna 88 may be coupled to the gaming device 10 through a peripheral device. In still another embodiment, the mobile terminal 68 may dock with the gaming device 10 through a docking cradle 90. Again, the docking cradle 90 may be incorporated into a peripheral device. In yet another embodiment, a dedicated docking station 92 may be provided, and the mobile terminal 68 may be coupled to the network 64 through the docking station 92. In yet another embodiment, a cellular microstation 94 may be communicatively coupled to the network 64 and the mobile terminal 68 may interoperate with the microstation 94. Other arrangements are also contemplated.

Instead of conducting game play on the mobile terminal 68, the mobile terminal 68 may form part of a user interface. For example, a player may use the display 16 of a gaming device 10, but issue commands related to game play through the mobile terminal 68, or the player may use input keypad 20 to issue commands, but see results on a display of the mobile terminal 68. Again, the mobile terminal 68 may communicate with the gaming device 10 using any appropriate mechanism.

While the discussion above focuses on the gaming device 10 being a video or reeled slot machine, it should be appreciated that the concepts disclosed herein are readily adapted to video poker terminals, video blackjack terminals, video roulette terminals, video keno terminals, video lottery terminals, pachinko terminals, or the like, and all are contemplated within the present disclosure.

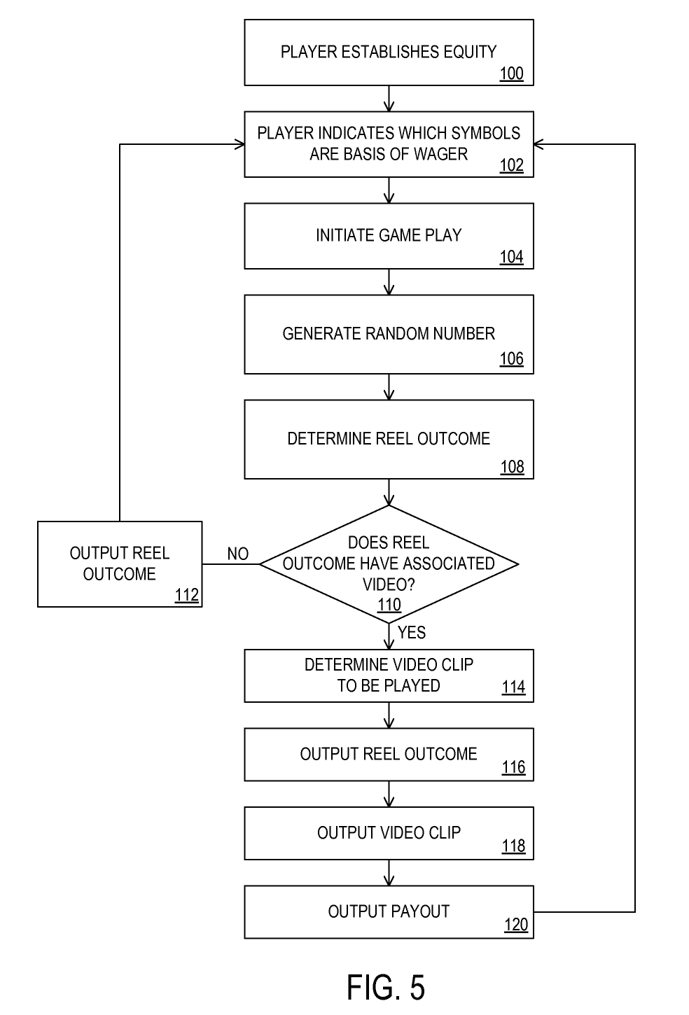

Against this backdrop of hardware, the present disclosure now turns to exemplary methods of using this hardware. An exemplary method is presented with reference to FIG. 5. In this exemplary method, the player approaches the gaming device 10 and establishes equity on the gaming device 10 (block 100). Equity may be established through any technique discussed above. The player then indicates which symbol(s) is the basis of the player's wager (block 102). That is, the gaming device 10 presents a plurality of symbols on which the player may wager through the wager buttons 36. The player presses or otherwise actuates the wager buttons 36 corresponding to the one or more symbols from the plurality of symbols on which the player is wagering. In an exemplary embodiment, the selected symbols may change their appearance on the player interface 50 so as to draw attention to the fact that the player has selected the symbol. For example, if the wager buttons 36 are normally lit, the selection may cause them to darken. Conversely, if the wager buttons are normally dark, the selection may cause them to illuminate. Other highlighting techniques include: changing color, changing size, outlining, or the like. Still other techniques are possible, especially if the wager buttons 36 are not electromechanical buttons but are formed within a touch screen.

The player then initiates game play (block 104) such as by pressing the spin button 40, pulling the handle 42 or other technique as desired. The control system then generates a random number (block 106) with the random number generator 56. The generated random number is then coupled with the wager that the player made, and particularly with the symbols on which the player wagered, and a reel outcome is determined (block 108). This determination may be made through a look up table, a database, or the like. For example, as illustrated in FIG. 6, a payout database 150 may be used. The random number is evaluated, then matched with the wager selection made by the player. Based on those two pieces of information, a reel outcome and audiovisual clip (if any) are determined along with a payout. More information about payout database 150 is provided below.

The control system determines if the reel outcome has an associated audiovisual clip (block 110). This determination may be made with reference to the payout database 150. If the reel outcome does not have an associated audiovisual clip then the gaming device 10 outputs the reel outcome on the display 16 (block 112) and the process repeats as indicated. Using the exemplary embodiment of payout database 150, if the random number generated were between 8570 and 10218, then block 110 would be answered negatively, a blank-blank-blank would appear on reels 32 at block 112, and the process would repeat.

If, however, the reel outcome has an associated audiovisual clip, the control system determines which audiovisual clip is to be played (block 114). Again, this determination may be made with reference to the payout database 150. The gaming device 10 then outputs the reel outcome (block 116) and the audiovisual clip (block 118) and informs the player of a payout that the player is due (block 120). The process then repeats.

The payout database 150 is an exemplary database that translates the generated random number into a reel outcome and an associated audiovisual clip. The payout database 150 includes a random number field 152, a wager selection field 154, a reel outcome field 156, an audiovisual clip field 158, and a payout field 160. The random number field 152 stores numbers corresponding to potential outcomes from the random number generator 56. The wager selection field 154 stores possible wager selections made by the player. In the exemplary database, each possible random number has a corresponding entry in wager selection field 154 for every possible combinations and permutations of the player selectable symbols (e.g., JACK, CHRISSY, JANET, JACK-CHRISSY, JACK-JANET, JANET-CHRISSY, JACK-JANET-CHRISSY, etc.). The number of entries for each random number goes up depending on the number of player selectable symbols. The equation for the number of entries is as follows:

$${\sum }_{r = 1}^{n} \frac{n !}{( n - r ) ! r !}$$

The reel outcome field 156 has an entry for every random number-wager selection combination. As particularly contemplated, if the player is due a payout, then the player will first be shown a reel outcome that includes at least one of the symbols on which she wagered and then shown an audiovisual clip which includes the character or element on which she wagered. Thus, if the random number corresponds to a payout, then the reel outcome should include a symbol corresponding to at least one of the symbols on which the player wagered.

The audiovisual clip field 158 has an entry identifying which of the audiovisual clips stored in the memory 60 (or memory 74) corresponds to the reel outcome. For non-winning outcomes, in an exemplary embodiment, no audiovisual clip will be provided. The entry may be a hyperlink to the audiovisual clip or other instructions on how to access the audiovisual clip as desired.

The payout field 160 indicates how many credits are to be paid to the player based on the random number.

While database 150 is one particular way to implement the determining, other techniques are possible. For example, a first random number may be used to determine a reel outcome and a payout and a second random number may be used to determine which audiovisual clip to play. Alternatively, each combination and permutation of player selectable symbols may have its own database such that when the player initiates the game play, the control system first accesses the appropriate database corresponding to the selected symbols, then determines the random number, which dictates the reel outcome and the audiovisual clip.

As variation on the methods discussed above, it is also possible to associate each symbol on which the player may wager with a multiplier. For example, JACK is a one-credit multiplier, CHRISSY is a two-credit multiplier, JANET is a two-credit multiplier, MR. ROPER is a three-credit multiplier, and so on. Then, during presentation of the audiovisual clip, the player is provided an indication as to a base payout associated with the audiovisual clip. The base payout is then multiplied by the multiplier and the player is informed of his final payout. An exemplary version of this methodology is presented in FIG. 7.

The player establishes equity in the gaming device 10 as previously described (block 200). The player indicates which symbols form the basis of the player's wager (block 202). Some players may select certain symbols based on the multiplier associated with the symbol. Other players may select symbols based on their fondness for a character or prop. Regardless of reason, the player is afforded at least the illusion that the selection changes the payout ultimately provided. Note that in a variant embodiment, selecting a symbol with a multiplier greater than one associated therewith may require more than a single credit wager. For example, selecting a symbol with a 2× multiplier associated therewith may require a two credit wager. In still another example, selecting a symbol with a 5× multiplier may require a three credit wager. The ratio of multiplier to wager requirement is not fixed and may be varied as desired.

The player initiates game play (block 204). The control system has the random number generator 56 generate a random number (block 206). The random number is used to determine an outcome (block 208). Based on the outcome, the control system determines whether the outcome has an associated video (block 210). As noted above, the process of determining the outcome and whether there is an associated video may be done with reference to a database, through a look up table, or the like. If the answer to block 210 is no, then the outcome is presented to the player (block 212) as a reel outcome and the process repeats.

If, however, the answer to block 210 is yes, then the reel outcome is presented to the player and then the audiovisual clip is played (block 214). While the audiovisual clip is playing, a base payout may be communicated to the player. In an exemplary embodiment, a second meter shows a base payout scaling along with an element within the video (block 216). For example, a sliding bar may act as a sort of “Laugh-o-meter” that slides to the right the more laughter there is within the audiovisual clip. Instead of laughter, it could be a character's monologue time duration, a time duration for how long a character performs a certain activity, the number of punches a boxer lands, or any other measurable occurrence indicated by the video.

The base payout is then compared to any multipliers associated with the symbols selected by the player (block 218) and a payout is output to the player (block 220). For example, if the laugh-o-meter shows a base payout of ten credits and the player wagered on Chrissy (a ×2 multiplier) and Jack (a ×1 multiplier), the player may be shown the base payout ×1 (Jack) ×2 (Chrissy) for a final payout of twenty credits. The process then repeats as noted.

If the player has made a multiple credit wager on a particular symbol, then it may be factored into the final payout as well. For example, if the player bet 2 credits on Jack and 1 credit on Chrissy, then the payout might be 40 credits (10 credits×(2 credit wager×1 (Jack multiplier))×(1 credit wager×2 (Chrissy multiplier)).

### Variations

Instead of electromechanical buttons 36, the buttons may be incorporated into a touch screen display. This touch screen display may be part of displays 16, 18, 28, or its own display as desired. The buttons could be part of a menu screen with appropriate instructive text (e.g., “select the characters you would like to bet on”), a persistent “select-a-symbol” bar that runs along the edge of a display (e.g., horizontally, vertically), or the like as desired. As noted above, the player may vary her bet on a particular symbol. While not shown, a max bet button may be provided such that each symbol is bet and a maximum credit per symbol wager is bet.

Various elements may be used as symbols. Particularly contemplated elements are characters, persons, animated characters, actors, athletes, objects including scenery in a cartoon, props on the television show or movie (e.g., cards, couches, lamps, coffee cups, etc.), sporting equipment (e.g., balls), colors on an object or attire, actions performed by a character or athlete (e.g., hitting a three point shot in basketball), audio elements including words, phrases, laughter, music, or sound effects, and the like. This list is meant to be exemplary and non-limiting.

The manner in which the symbols are presented to the player may be varied. For example, pictures, photos, sketches, caricatures, speech bubbles, subtext, and the like may all be used to help explain to the player what symbol on the reels forms the basis of the player's wager and will be shown in the audiovisual clip.

The determination of the payout may also be varied. For example, rather than determine the final outcome with the initial random number and work backwards to the audiovisual clip and the reel outcome, the initial random number may merely determine the reel outcome and a base payout and then the player's wager and multiplier (if any) are applied to the base payout. This embodiment makes it more difficult to calculate the effective hold percentage of the gaming device, but there is no strict reason why a particular order has to be imposed in making the determination of the payout.

It is further worth noting that particular audiovisual clips may not necessarily be tied to particular base payout amounts. One clip could be reused for different base payouts depending on, for example, the wager placed by the player. A clip that is fifteen seconds long and has JACK speaking for ten seconds and CHRISSY speaking for five seconds could be worth 10 credits as a base payout for a player who wagered on JACK, but only five credits as a base payout for a player who wagered on CHRISSY, and fifteen credits base payout for the player who wagered on both. Alternatively, the base payout could be independently randomly determined relative to selection of the audiovisual clip.

Additionally, payout amounts may be determined based only on which indicia a player has wagered on compared to a random number. That is, there may not be a particular payout amount for a given random number; rather, the payout amount is based on whether the indicia that a player has wagered on appear on the reels. For example, a player wagers two credits on JACK. She presses the spin button and the random number generator determines a random number, which corresponds to a reel outcome of CHRISSY-CHRISSY-JACK, which yields a two-credit payout based on the player's wager (i.e., one occurrence×two credit wager). However, the same random number may pay zero credits if presented to a player who has wagered two credits on JANET (i.e., zero occurrence×two credit wager), because the character JANET did not appear in the reel outcome.

The nature of the laugh-o-meter may change. For example, the laugh-o-meter could measure the duration or the volume of the laughter. Alternatively, players could vote and provide an empirical definition for the laugh-o-meter. A microphone could measure player laughter and use that to derive a laugh-o-meter value empirically.

There may be variations in conditions applied before a particular symbol is eligible for wagering or whether audiovisual clips are played as part of the outcome revelation. For example, as discussed above, some characters may require minimum wagers of more than one credit. Alternatively, more than one credit may be required in the wager before audiovisual clips are played for the player. In another embodiment, a player must wager on a certain number of symbols before becoming eligible for audiovisual playback. Still another variation might be that the player has to maintain a certain credit balance on the gaming device 10 before becoming eligible for audiovisual clip playback.

Another variation is to have multiple paylines. Instead of the single payline 34 shown in FIG. 1, three, five, nine or more paylines may be available. This variation is especially applicable to five reel video slot machines, where large numbers of paylines are readily possible. The number of paylines activated may be a function of the wager made by the player, the number of symbols on which the player wagers, or other technique as is readily understood.

Instead of a laugh-o-meter, a sports scoreboard, a fright-o-meter, or other scale may be used to illustrate the base payout.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

A player “wagers” at least a single “unit of wager” to pay for a game start. In many gaming devices, a unit of wager may be referred to as a credit. Many gaming devices allow multiple credits to be wagered concurrently in exchange for an improved paytable or more paylines. A unit of wager may be equivalent to a full dollar amount ($1, $5), a fractional dollar amount, a coin (e.g., $0.05 (nickel) or $0.25 (quarter)), or specified amount of another currency (e.g., a specified number of comp points). Some paytables may be expressed as a number of coins won relative to a number of coins wagered. In such instances, the term coin is the same as a unit of wager. Because gaming devices are embodied in different denominations, it is relevant to note that a coin, credit, or unit of wager on a first device may not be identically valued as a coin, credit, or unit of wager on a second device. For example, a credit on a quarter slot machine (on which the credit is equivalent to $0.25) is not the same as a credit on a five dollar slot machine (on which the credit is equivalent to $5.00). Accordingly, it should be understood that in embodiments in which a player may cash out credits from a first gaming device that operates based on a first denomination (e.g., a quarter-play slot machine) and establish, using only the cashed out credits, a credit balance on a second gaming device that operates based on a second denomination (e.g., a nickel-play slot machine), the player may receive a different number of credits on the second gaming device than the number of credits cashed out at the first gaming device. An interesting discussion of this concept can be found in U.S. Pat. No. 5,277,424, which is hereby incorporated by reference in its entirety.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure frequently refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

What is claimed is:

1. A method comprising:
receiving from a player of a gaming device an indication as to which selected one of a plurality of symbols on which the player is wagering;
initiating a game start;
determining an outcome for the game start; and
providing the outcome to the player by:
displaying a plurality of reels with at least a subset of the plurality of symbols on a payline;
if the selected one of the plurality of symbols is positioned on the payline, displaying an output audiovisual clip to the player, wherein the output audiovisual clip features a characteristic indicated by the selected symbol; and
informing the player of the outcome.

2. The method of claim 1 further comprising receiving from the player of the gaming device indications as to a plurality of selected symbols on which the player is wagering.

3. The method of claim 1 wherein determining the outcome comprises determining a random number.

4. The method of claim 3 further comprising using the random number to determine which of the plurality of symbols to display on the payline and which of a plurality of audiovisual clips to display as the output audiovisual clip to the player.

5. The method of claim 1 further comprising indicating that certain ones of the plurality of symbols act as multipliers on a base payout.

6. The method of claim 5 further comprising indicating to the player the base payout after displaying the plurality of reels with at least the subset of the plurality of symbols on the payline.

7. The method of claim 6 wherein informing the player of the outcome comprises showing the player the base payout being multiplied by the multiplier to provide a final payout.

8. The method of claim 6 wherein informing the player of the outcome comprises showing the player the base payout being multiplied by the multiplier and by a wager amount.

9. The method of claim 1 wherein receiving from the player the indication comprises receiving an input through at least one of: a touch screen and a button.

10. The method of claim 1 wherein the plurality of symbols are thematically tied to the output audiovisual clip.

11. The method of claim 10 wherein at least one of the plurality of symbols comprises at least one of, a character, an object, a color, or a stylized representation of an action taken by a character.

12. The method of claim 1 further comprising selecting the output audiovisual clip from amongst a plurality of audiovisual clips.

13. The method of claim 1 wherein the audiovisual clip comprises at least one characteristic from a set of characteristics including a character, an object, a color, an utter of a word, an utterance of a phrase, laughter, music, a sound effect, and an action taken by a character.

14. The method of claim 1 wherein displaying the plurality of reels comprises displaying at least one of a physical reel and a virtual reel.

15. The method of claim 1 wherein informing the player of the outcome comprises informing the player through a mobile terminal.

16. The method of claim 1 further comprising accessing a database of audiovisual clips.

17. The method of claim 16 wherein accessing the database of audiovisual clips comprises accessing a local database.

18. The method of claim 16 wherein accessing the database of audiovisual clips comprises accessing a database on a central server.

19. The method of claim 1 wherein output audiovisual clip comprises an audiovisual clip that has been repurposed from its original purpose for use on the gaming device.

20. The method of claim 19 wherein the audiovisual clip has an original purpose of: a television show, a movie, a sporting event, a comedian sketch, and music concert.

21. The method of claim 1 wherein the symbol selected by the player is marked by a graphical change to both the symbol as depicted by the reels and the symbol as depicted by an input device used to select the symbol.

22. The method of claim 21 wherein the graphical change comprises at least one of: darkening, illuminating, outlining, highlighting, changing a color, and changing a size.

23. A system comprising:
a user interface; and
a control system operatively coupled to the user interface and adapted to:
receive from a player of a gaming device an indication as to which selected one of a plurality of symbols on which the player is wagering;
initiate a game start;
determine an outcome for the game start; and
provide the outcome to the player by:
display a plurality of reels with at least a subset of the plurality of symbols on a payline;
if the selected one of the plurality of symbols is positioned on the payline, display an output audiovisual clip to the player, wherein the output audiovisual clip features a characteristic indicated by the selected symbol; and
inform the player of the outcome.

24. The system of claim 23 wherein the user interface comprises a mobile terminal.

25. The system of claim 23 wherein the control system comprises a central server.

26. The system of claim 23 wherein the control system is further adapted to access electronic memory comprising a plurality of audiovisual clips.

27. A computer readable medium comprising software with instructions to:
receive from a player of a gaming device an indication as to which selected one of a plurality of symbols on which the player is wagering;
initiate a game start;
determine an outcome for the game start; and
provide the outcome to the player by:
display a plurality of reels with at least a subset of the plurality of symbols on a payline;
if the selected one of the plurality of symbols is positioned on the payline, display an output audiovisual clip to the player, wherein the output audiovisual clip features a characteristic indicated by the selected symbol; and
inform the player of the outcome.

28. A method comprising:
providing a plurality of thematically linked audiovisual clips that have been repurposed from their original purpose for use on a gaming device;
presenting a plurality of inputs on a gaming device, wherein each input corresponds to a different element, each of the different elements being present in at least one of the plurality of thematically linked audiovisual clips;
associating the different elements with reels of the gaming device;
receiving from a player an actuation of one or more of the plurality of inputs thereby indicating on which of the different elements the player is wagering;
determining a winning outcome; and
providing the winning outcome to the player by:
visually spinning the reels;
stopping the reels such that at least some elements are positioned on a payline;
if the at least some elements positioned on the payline correspond to the different elements on which the player is wagering, playing an audiovisual clip selected from the plurality of thematically linked audiovisual clips; and
informing the player of a payout.
